(19) United States
(12) Patent Application Publication
(10) Pub. No.: US 2014/0122145 A1
(43) Pub. Date: May 1, 2014

(54) SYSTEMS AND METHODS FOR SCHEDULING KNOWLEDGE SHARING SESSIONS

(71) Applicants: Michael Y. Lim, San Ramon, CA (US); Kang S. Lim, San Ramon, CA (US)

(72) Inventors: Michael Y. Lim, San Ramon, CA (US); Kang S. Lim, San Ramon, CA (US)

(21) Appl. No.: 14/069,305

(22) Filed: Oct. 31, 2013

Related U.S. Application Data
(60) Provisional application No. 61/721,441, filed on Nov. 1, 2012.

(51) Int. Cl. G06Q 10/10; G06Q 10/06

(52) U.S. Cl. CPC G06Q 10/1095; G06Q 10/063112
USPC 705/7.14

(57) ABSTRACT

A flexible scheduler for matching knowledge seeker(s) with a knowledge provider of a specific subject matter is provided. The scheduler searches a knowledge provider database to identify at least one knowledge provider skilled in the specified subject matter. If no match is found, then the scheduler seeks and selects a new knowledge provider skilled in the specified subject matter. Finally, the scheduler schedules the knowledge sharing session by weighing seeker(s) preferred timeslots and weighing selected provider preferred timeslots.

### CROSS REFERENCE TO RELATED APPLICATION

This non-provisional application claims the benefit of provisional application No. 61/721,441 filed on Nov. 1, 2012, entitled “Systems and Methods for Scheduling Knowledge Sharing Sessions”, which application is incorporated herein in its entirety by this reference.

### BACKGROUND

The present invention relates to systems and methods for scheduling knowledge sharing sessions.

Generally, learning is ad hoc, e.g., a mentor with an individual mentee or an experienced supervisor with an employee. Conversely, at most teaching institutions, classes for groups of students are generally pre-scheduled. As a result, there is very little flexibility for the instructor(s) and even less flexibility for the students.

It is therefore apparent that an urgent need exists for flexible scheduling systems enabling groups of students to schedule knowledge sharing sessions at mutually convenient timeslots.

### SUMMARY

To achieve the foregoing and in accordance with the present invention, systems and methods for scheduling knowledge sharing sessions.

In one embodiment, a flexible scheduler matches knowledge seeker(s) with a knowledge provider of a specific subject matter. The scheduler searches a knowledge provider database to identify at least one knowledge provider skilled in the specified subject matter. If no match is found, then the scheduler seeks and selects a new knowledge provider skilled in the specified subject matter. Finally, the scheduler schedules the knowledge sharing session by weighing seeker(s) preferred timeslots and weighing selected provider preferred timeslots.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIGS. 1-4 are flow diagrams illustrating one embodiment of a knowledge sharing scheduling system in accordance with the present invention;

FIGS. 5A and 5B illustrate a computer system suitable for implementing the scheduling system of FIGS. 1-4;

FIG. 6A illustrates a plurality of knowledge seeker computer system coupled via a wide area network to the scheduling system of FIGS. 1-4; and

FIG. 6B illustrates a plurality of knowledge seeker computer systems and a plurality of knowledge provider computer systems coupled via a wide area network to the scheduling system of FIGS. 1-4.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

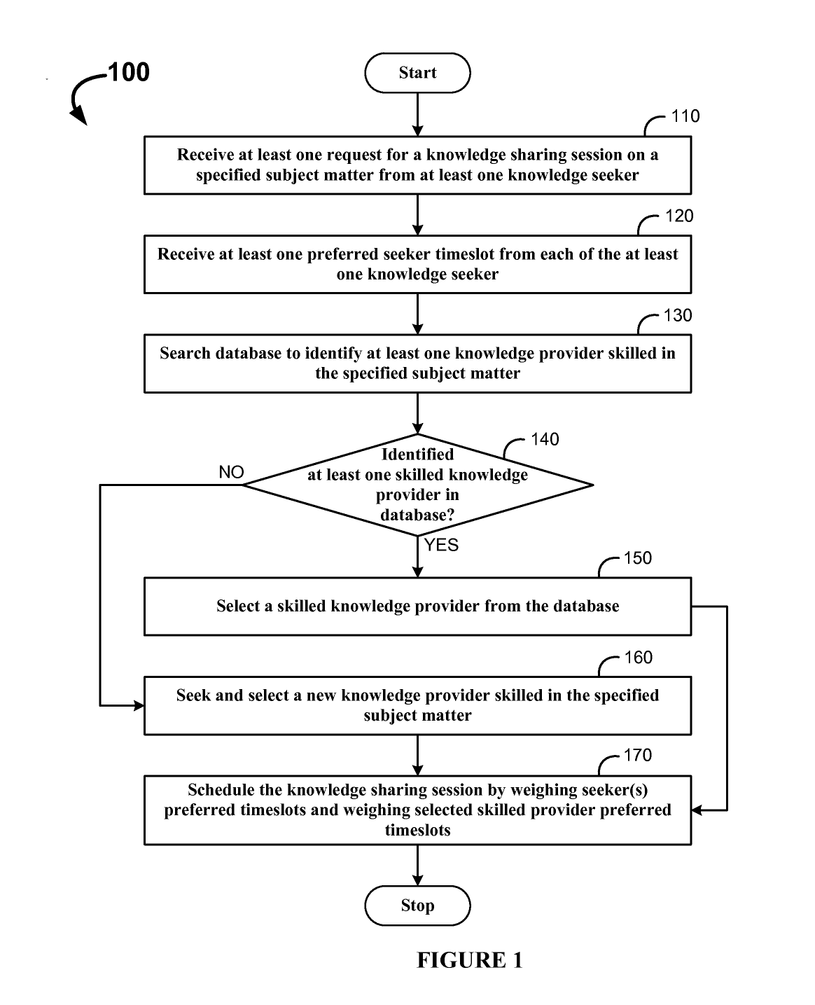

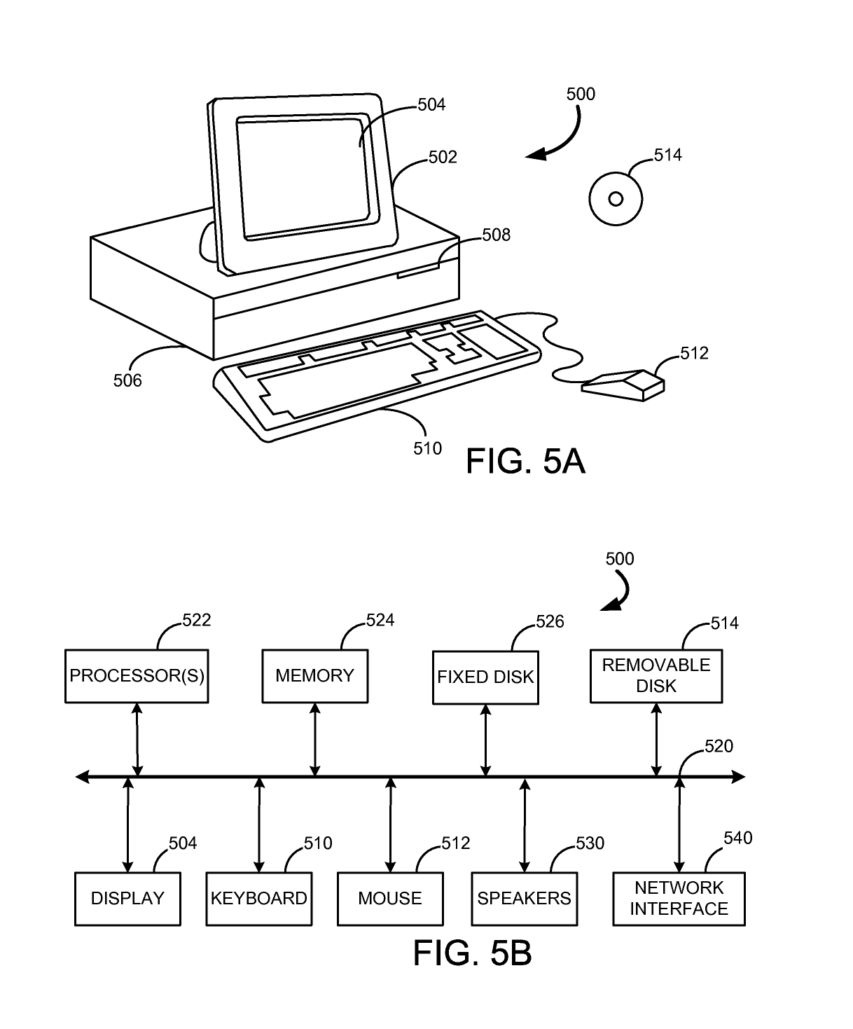

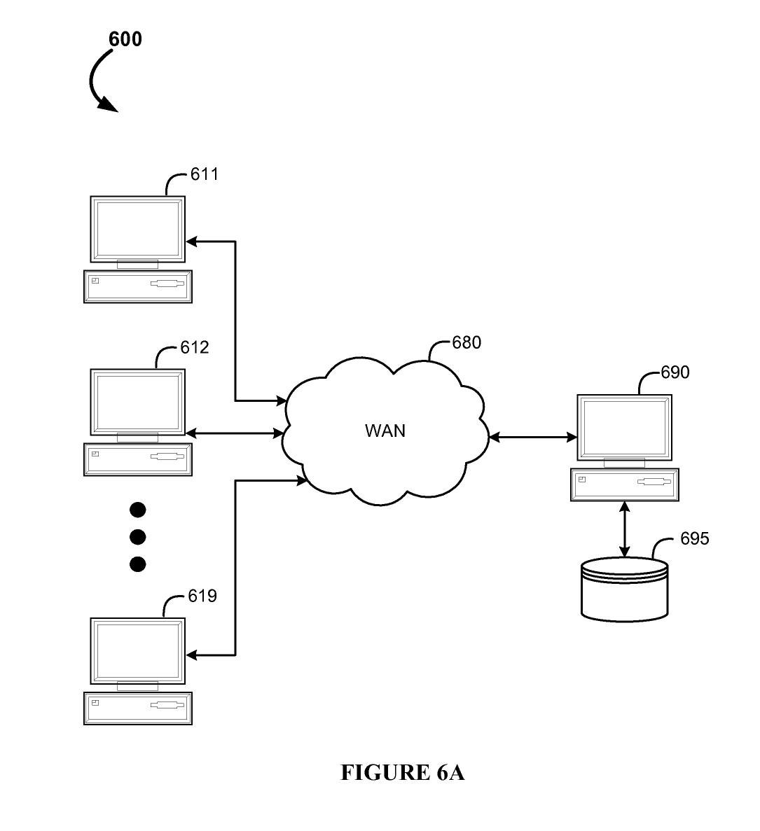

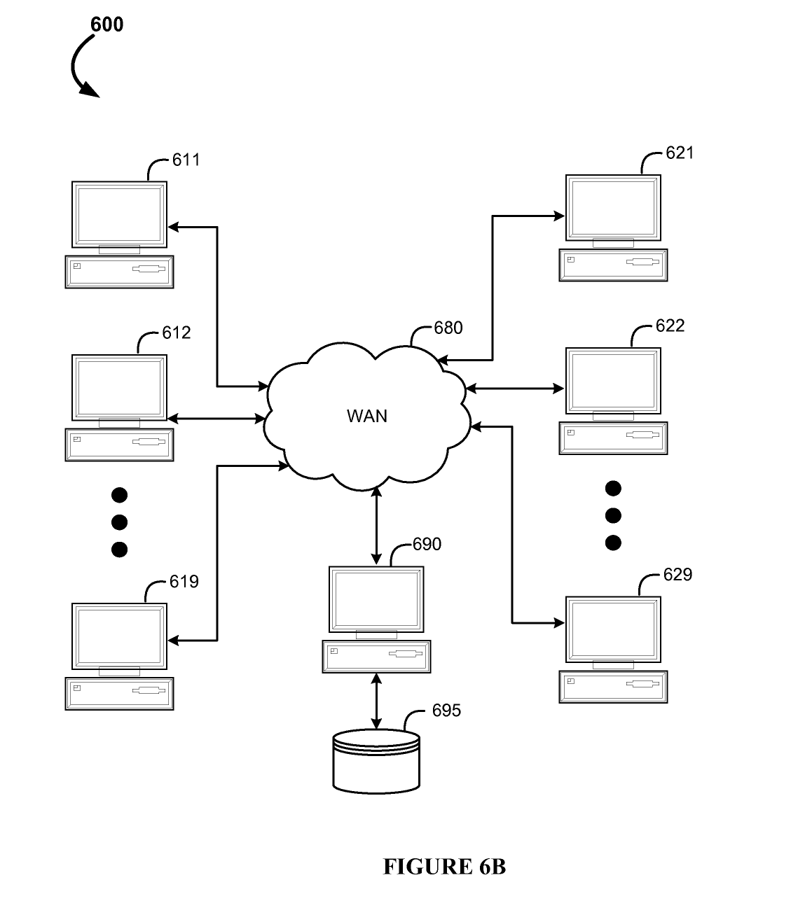

The present invention relates to systems and methods for scheduling knowledge sharing sessions with a plurality of attendees. To facilitate discussion, FIGS. 1-4 are flow diagrams illustrating one embodiment of the scheduling system in accordance with the present invention. FIGS. 5A and 5B are functional diagrams showing an exemplary computer system suitable for implementing the scheduling flow diagrams of FIGS. 1-4, while FIG. 6B illustrates a plurality of potential knowledge seekers 611, 612 . . . 619, a plurality of potential knowledge providers 621, 622 . . . 629 and a scheduler 690 coupled to a knowledge provider database 695, coupled to each other via a wide area network 680, such as the internet.

Referring to FIGS. 1 and 6B, one or more knowledge seekers sends request(s) to scheduler 690 for a knowledge sharing session on a specific subject matter (step 110). The subject matter can be selected from a pre-existing list of topics provided by scheduler 690 or the knowledge seeker(s) can provide a customized subject matter to scheduler. The knowledge seeker(s) provides scheduler 690 with at least one preferred timeslot (step 120). Multiple timeslots may be ranked by the knowledge seeker(s) according to seeker preference.

In step 130, scheduler 690 searches the knowledge provider database 695 for at least one suitable knowledge provider skilled at the request subject matter using search and/or semantics processing algorithms known to one skilled in the art.

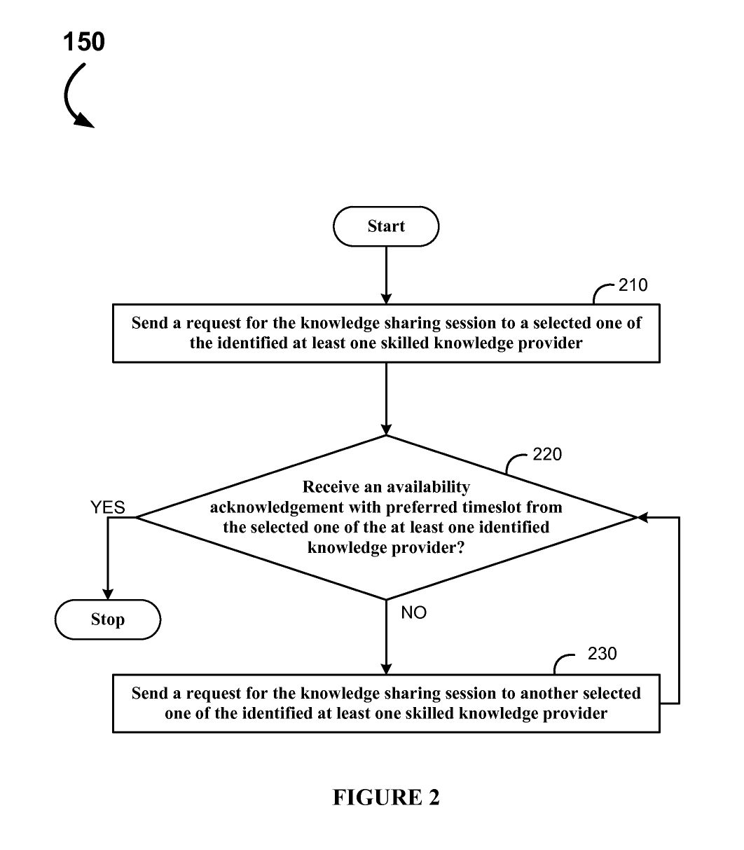

If one or more skilled knowledge providers is identified (step 140), as illustrated by flow diagram 150 of FIG. 2, scheduler 690 sends a request to the identified knowledge provider(s) (step 210). Subsequently, one or more identified knowledge provider(s) sends an availability acknowledgement with preferred timeslot(s) to scheduler 690 (step 220). Multiple timeslots may be ranked by the knowledge providers(s) according to provider preference.

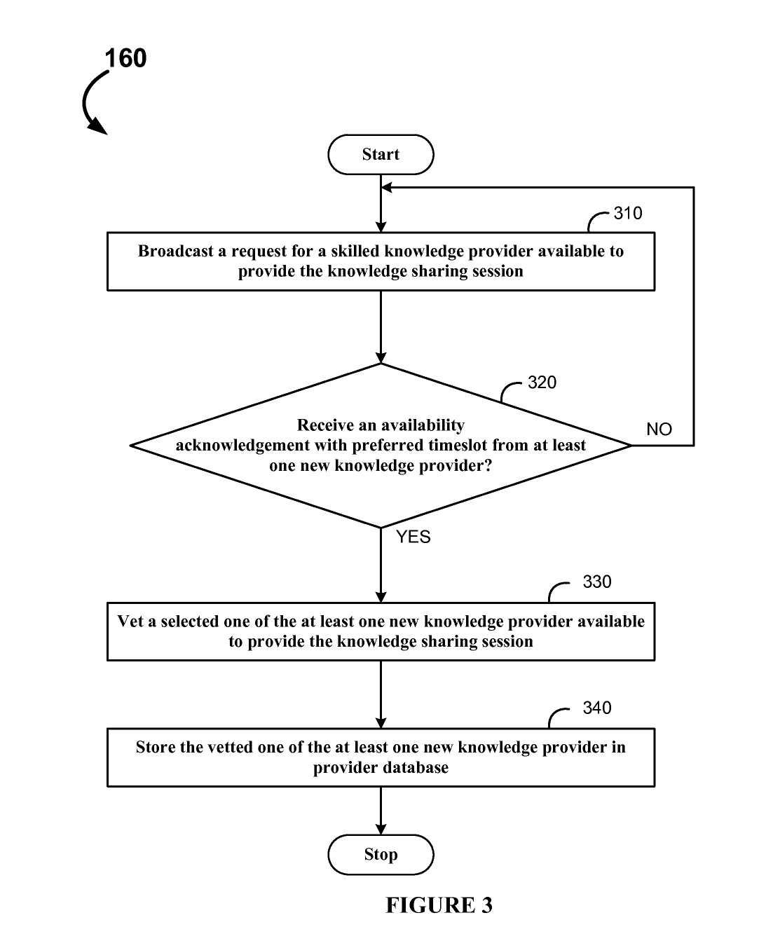

Conversely, if no knowledge provider skilled in the specified subject matter is found in the provider database 595 (step 140), as illustrated by flow diagram 160 of FIG. 3, scheduler 690 sends a request for a skilled knowledge provider available to provide the knowledge sharing session (step 310). When at least one skilled knowledge provider responds with at least one preferred timeslot (step 320), scheduler 690 selects and vets the responding skilled knowledge provider(s) (step 330). Scheduler 690 may store one or more of the responding skilled knowledge provider(s) in the knowledge provider database 695 (step 340).

Referring back to step 170 of FIG. 1, scheduler 690 can schedule the knowledge sharing session by comparing and/or weighing seeker preferred timeslot(s) with provider preferred timeslot(s). If there is no single solution that satisfies all the knowledge seeker preferred timeslots, scheduler 690 may schedule multiple sessions.

Scheduler 690 may also process payments for the knowledge sharing session based on pricing models known to one skilled in the arts, including price-matching and/or cost-sharing strategies.

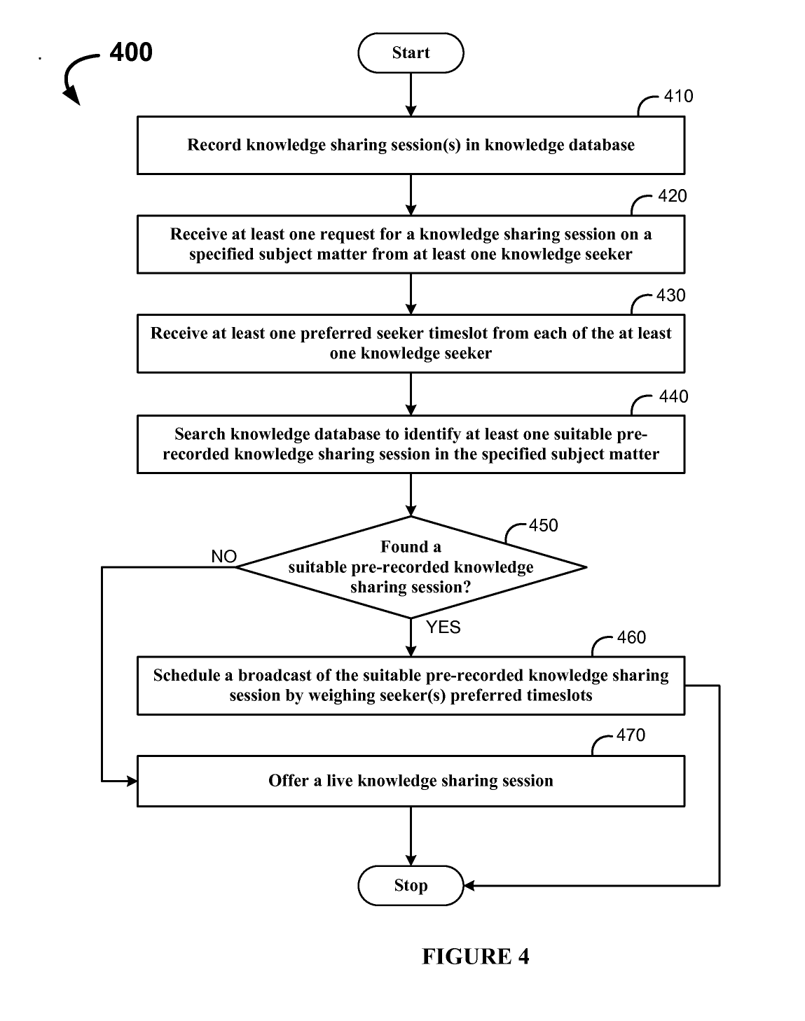

In some embodiments, as illustrated by flow diagram 400 of FIG. 4 and the block diagram of FIG. 6A, scheduler 690 may offer pre-recorded knowledge sharing session(s). When scheduler 690 receives a request for a specified knowledge sharing session with preferred timeslots from at least one knowledge seeker (steps 420, 430), scheduler 690 searches a knowledge database (not shown) for such a knowledge sharing session (step 440). It is also possible for scheduler 690 to search external database(s) over a wide area network, such as the internet, for such a pre-recorded knowledge sharing session.

If a suitable pre-recorded knowledge sharing session is found (step 450), then scheduler 690 schedules a broadcast of the selected pre-recorded knowledge sharing session by weighing seeker preferred timeslots (step 460). Conversely, if no suitable pre-recorded knowledge sharing session is found, as shown in step 470, scheduler 690 may offer a live knowledge sharing session to the knowledge sharing seeker(s), such as in the manner described above in the flow diagram 100 of FIG. 1.

Many modifications and additions are also possible. For example, it is also possible to incorporate auction strategies known to one skilled in the art such as bidding, silent bids, private bids and public bids.

Advantages of the above described embodiments of scheduling system include increased flexibility, increased capacity, increased market share and improved profitability.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for scheduling knowledge sharing sessions useful in association with at least one knowledge seeker, the scheduling method comprising:
receiving at least one request for a knowledge sharing session on a specified subject matter from at least one knowledge seeker;
receiving at least one preferred seeker timeslot from each of the at least one knowledge seeker;
searching a knowledge provider database to identify at least one knowledge provider skilled in the specified subject matter;
if at least one skilled knowledge provider is identified, then selecting a skilled knowledge provider from the provider database;
else if no skilled knowledge provider is identified, then seeking and selecting a new knowledge provider skilled in the specified subject matter; and
scheduling the knowledge sharing session by weighing at least one seeker preferred timeslot and weighing at least one provider preferred timeslot.

2. The scheduling method of claim 1 wherein selecting the knowledge provider from the provider database includes sending a request for the knowledge sharing session to a selected one of the identified at least one skilled knowledge provider, and further includes receiving an availability acknowledgement with preferred timeslot from the selected one of the at least one identified knowledge provider.

3. The scheduling method of claim 1 wherein seeking and selecting a new knowledge provider skilled in the specified subject matter includes:
sending a request for a skilled knowledge provider available to provide the knowledge sharing session;
receiving an availability acknowledgement with preferred timeslot from at least one new knowledge provider; and
vetting a selected one of the at least one new knowledge provider available to provide the knowledge sharing session.

4. The scheduling method of claim 3 further comprising storing the vetted one of the at least one new knowledge provider in the provider database.

5. A scheduler configured to schedule knowledge sharing sessions useful in association with at least one knowledge seeker, the scheduler comprising:
a knowledge provider database configured to store at least one knowledge provider skilled in at least one specific subject matter; and
a processor configured to:
receive at least one request for a knowledge sharing session on a specified subject matter from at least one knowledge seeker;
receive at least one preferred seeker timeslot from each of the at least one knowledge seeker;
search the knowledge provider database to identify at least one knowledge provider skilled in the specified subject matter;
if at least one skilled knowledge provider is identified, then select a skilled knowledge provider from the knowledge provider database;
else if no skilled knowledge provider is identified, then seek and select a new knowledge provider skilled in the specified subject matter; and
schedule the knowledge sharing session by weighing at least one seeker preferred timeslot and weighing at least one provider preferred timeslot.

6. The scheduler of claim 5 wherein the processor is configured to send a request for the knowledge sharing session to a selected one of the identified at least one skilled knowledge provider, and further configured to receive an availability acknowledgement with preferred timeslot from the selected one of the at least one identified knowledge provider.

7. The scheduler of claim 5 wherein the processor is configured to:
send a request for a skilled knowledge provider available to provide the knowledge sharing session;
receive an availability acknowledgement with preferred timeslot from at least one new knowledge provider; and
vet a selected one of the at least one new knowledge provider available to provide the knowledge sharing session.

8. The scheduler of claim 7 wherein the processor is further configured to store the vetted one of the at least one new knowledge provider in the provider database.
